(19) United States
(12) Patent Application Publication
(10) Pub. No.: US 2006/0097699 A1
(43) Pub. Date: May 11, 2006

(54) State of charge indicator for battery

(75) Inventor: Robert Kamenoff, Port Orange, FL (US)

Correspondence Address: RICHARD K. WARTHER;ALLEN, DYER,DOPPELT,MILBRATH & GILCHRIST P.A., 1401 CITRUS CENTER 255 SOUTH ORANGE AVENUE, P.O. BOX 3791, ORLANDO, FL, 32802-3791, US

(73) Assignee: MATHEWS ASSOCIATES, INC., Sanford, FL (US)

(21) Appl. No.: 11/260,945

(22) Filed: Oct. 28, 2005

Related U.S. Application Data
(60) Provisional application No. 60/625,393, filed on Nov. 5, 2004.

(51) Int. Cl. H02J 7/00

(52) U.S. Cl. 320/132

(57) ABSTRACT

A state of charge indicator includes a current sensing circuit for sensing and converting charge or discharge current of a battery into a bipolar voltage. A counter circuit counts battery charge. A charge/discharge circuit is operatively connected to the current sensing and counter circuits and detects the voltage polarity from the current sensing circuit and sets the counter circuit to a count mode with an up or down count for a respective charge or discharge. A reset circuit is operative with the current sensing circuit, counter circuit and charge/discharge circuit for resetting the counter circuit to an actual state-of-charge of the battery after delay when the battery is idle representative of a battery open circuit voltage.

### RELATED APPLICATION

This application is based upon prior filed copending provisional application Ser. No. 60/625,393 filed Nov. 5, 2004.

### FIELD OF THE INVENTION

This invention relates to state of charge indicators for batteries.

### BACKGROUND OF THE INVENTION

Many current battery systems require a state of charge indicator, sometimes referred to as a battery “gas gauge”, to indicate the state of charge, i.e., the available remaining energy left in the battery or in one or more battery cells forming the battery. One common system used for measuring the state of charge or remaining energy left in a battery is a coulomb counter. In typical circuit designs for these types of state of charge indicators using a coulomb counter, a current sensing circuit, such as a shunt resistor, senses the current from the battery. For example, the current can be measured into and out of a rechargeable battery, such as a lithium-ion battery as one non-limiting example. A monitoring circuit containing a coulomb counter monitors this shunt resistor and counts the coulombs of energy into and out of the battery. The output signal from the coulomb counter drives a display, such as a five segment LCD bar graph, or alternatively, the output signal is transmitted via a data bus to an external device for read-out and perhaps further processing.

In some cases, however, using the cell or battery terminal voltage is not a practical means for measuring the state of charge of the battery. In some battery chemistries, for example, a lithium-ion battery cell, the open circuit voltage of the cell or battery is an accurate indication of the state of charge. A problem develops, however, if the cell or battery configuration has a closed circuit voltage. The overall cell or battery temperature affects the internal resistance of the battery. As a result, the closed circuit voltage is a function of the a) state of charge, b) the overall cell or battery temperature, and hence, the cell or battery internal resistance, and c) the charge or discharge current of the cell or battery.

One shortcoming in the many current battery systems using state of charge indicators results when rechargeable batteries are assembled because the exact state of charge of the different cells is not known. Rechargeable battery cells are normally supplied by the manufacturer in a state of charge ranging in a wide range from about 20 to about 80 percent. Further, the state of charge changes with time because of self-discharge within the battery cell. As a result, when the entire battery is assembled, any state of charge indicator typically must be initialized or preset to the actual level of charge within the battery cells.

Also, through numerous charge and discharge cycles in rechargeable batteries, any coulomb counter errors tend to be cumulative, resulting in large errors as the battery ages. Some state of charge indicators will reset if a battery is subjected to a complete 100% discharge and charge cycle. If the battery does not have a full charge and discharge cycle, however, large errors may result. Further, while most state of charge indicator systems using coulomb counters correct for self-discharge, these systems accomplish this by measuring battery or individual battery cell temperatures and calculating the self-discharge rate for the particular battery cell chemistry. This is a complex calculation and is not always accurate.

In the case of primary batteries, the initialization is typically not a problem because new primary battery cells are typically fully charged. It is often desirable, however, to locate the state of charge indicator externally, in or near the equipment that the battery is powering. For example, many military radios have a state of charge indicator built directly into the radio housing. In this type of configuration, it is difficult for the state of charge indicator to determine the state of charge of the battery. Each time a battery is connected, the state of charge indicator must assume that the battery is new and fully charged.

### SUMMARY OF THE INVENTION

Therefore, it is an object of the present invention to provide a state of charge indicator for a battery that incorporates an automatic initialization or reset for different batteries and overcomes the disadvantages described above.

In one aspect, a state of charge indicator for battery includes a current sensing circuit for sensing and converting charge or discharge battery current into a bipolar voltage with one polarity representative of charge current and an opposite polarity representative of discharge current. A counter circuit counts the battery charge. A charge/discharge circuit is operatively connected to the current sensing circuit and counter circuit and detects the voltage polarity from the current sensing circuit and sets the counter circuit to a count mode having an up or down mode for a respective charge or discharge. A reset circuit is operative with the current sensing circuit, counter circuit and charge/discharge circuit for resetting the counter circuit to an actual state of charge at the battery after a delay when the battery is idle representative of a battery open circuit voltage.

In another aspect, the voltage measuring circuit is operatively connected to the counter circuit and measures battery terminal voltage and transmits a digital signal representative of the battery terminal voltage to the counter circuit. A reset circuit includes a timer circuit operative with the counter circuit for loading a digital signal from the voltage measuring circuit into the counter circuit after delay when the battery is idle as representative of a battery open circuit voltage and representative of remaining capacity for resetting the count within the counter circuit to the remaining battery capacity. A voltage-controlled oscillator can be operatively connected to the current sensing circuit and the counter circuit and output pulse signal to the counter circuit, having a frequency proportional to the battery current through the current sensing circuit. The reset circuit includes a comparator circuit operative with the voltage-controlled oscillator and the timer circuit for activating the timer circuit when the battery is idle. In yet another aspect, the current sensing circuit can be formed as a shunt device for producing a shunt bipolar voltage. A charge/discharge circuit includes a comparator that receives the bipolar voltage and detects voltage polarity and differentiates between battery charge and discharge. The charge/discharge circuit can be operative for setting the counter circuit to have an up count for charge and down count for discharge.

In yet another aspect, the counter circuit can be formed as a coulomb counter and can be formed as serially connected coulomb counters. In yet another aspect, a logic circuit is operatively connected to the counter circuit and receives any output from the counter circuit and outputs a display drive signal. A display is operatively connected to the logic circuit and receives the display drive signal and displays the state-of-charge of the battery.

In still another aspect, a state-of-charge indicator system for battery includes a counter circuit that counts battery charge. A voltage measuring circuit is operatively connected to the counter circuit for measuring battery terminal voltage and transmitting a digital signal representative of the battery terminal voltage to the counter circuit. A circuit is operative with the counter circuit and voltage measuring circuit and monitors current and detects when the battery has been idle, indicative that the battery has neither been charged nor discharged for a period of time, sufficient for allowing the battery to settle into a open circuit voltage state and resetting the counter circuit to an actual state-of-charge of the battery.

A method aspect is also set forth.

### BRIEF DESCRIPTION OF THE DRAWINGS

Other objects, features and advantages of the present invention will become apparent from the detailed description of the invention which follows, when considered in light of the accompanying drawings in which:

FIG. 1 is a block diagram of an example of a state of charge indicator for a battery in accordance with one non-limiting example of the invention.

FIG. 2 is a high-level flowchart showing basic functional steps used in the example circuit shown in FIG. 1.

### DETAILED DESCRIPTION OF THE PREFERRED EMBODIMENTS

Different embodiments will now be described more fully hereinafter with reference to the accompanying drawings, in which preferred embodiments are shown. Many different forms can be set forth and described embodiments should not be construed as limited to the embodiments set forth herein. Rather, these embodiments are provided so that this disclosure will be thorough and complete, and will fully convey the scope to those skilled in the art. Like numbers refer to like elements throughout, and prime notation is used to indicate similar elements in alternative embodiments.

An exemplary battery state of charge indicator in accordance with one non-limiting example of the invention incorporates an automatic initialization or reset circuit. In one non-limiting example, a battery terminal voltage is continually measured. A current sensing circuit monitors the current, such as through a shunt resistor, and detects when the battery has been idle, i.e., neither charged nor discharged, for a period of time sufficient in length to allow the battery cells forming the battery to settle to an open circuit voltage. At the end of this period of time, the battery terminal voltage corresponding to the open circuit voltage is used to reset a coulomb counter circuit to an actual state of charge of the battery.

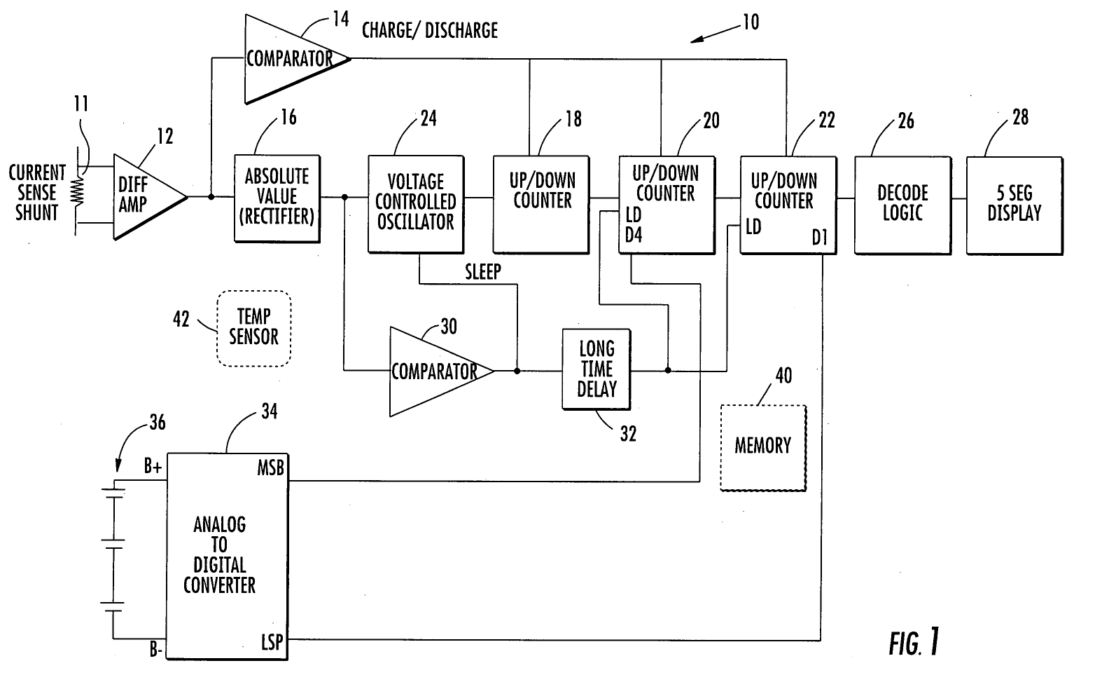

FIG. 1 is a block diagram for a state of charge indicator system 10 in accordance with one non-limiting example of the present invention used. This exemplary circuit can be adapted for use with a rechargeable battery, for example, a lithium-ion battery, formed from one or more battery cells arranged and configured to form a rechargeable battery.

A current sensing circuit 11 can be formed as a shunt resistor and converts the battery charge or the discharge current into a bipolar voltage. One polarity is typically unique to the charge current and an opposite polarity is unique to the discharge current. A differential amplifier 12 receives a low level shunt voltage and amplifies this voltage and inputs it into a charge/discharge comparator 14 and absolute value circuit 16 formed in one non-limiting example as a precision rectifier. The charge/discharge comparator 14 detects the shunt voltage polarity and differentiates between the battery charge function and battery discharge function and sets appropriate coulomb counters 18, 20 and 22 to an appropriate count mode, such as an up-count for the charge function and down-count for a discharge function. The absolute value circuit 16 as a precision rectifier converts the amplifier shunt voltage to a unipolar signal and drives a voltage controlled oscillator 24, which outputs a string of pulses having a frequency that is directly proportional to the battery current passing through the current sensing circuit 11.

The counters 18, 20 and 22 count the oscillator pulses. Typically an up-count is for the charge function and a down-count is for the discharge function as controlled by the charge/discharge comparator 14. A decode logic circuit 26 receives signals from the last coulomb counter 22 and drives a five (5) segment display 28, which displays the percentage of remaining battery capacity and/or the number of remaining battery recharge cycles proportional to the number of bars or stars or other segments, i.e., display indicia.

A sleep comparator 30 receives a signal from the absolute value circuit 16. The sleep comparator 30 feeds part of its output back to the voltage-controlled oscillator 24 and inhibits the oscillator when the battery charge or discharge current is below a predetermined minimum value. This ensures that the voltage-controlled oscillator 24 does not run at an undesired slow rate when the battery is idle. Also, the sleep comparator 30 activates a “long-time” timer delay circuit 32 whenever the battery is idle. An analog-to-digital converter circuit 34 measures the battery voltage from the battery 36, such as formed from a plurality of battery cells 38, and converts the measured analog voltage signal into a digital signal, and places this digital signal at the low inputs of the second and third coulomb counters 20 and 22 in this non-limiting example. Whenever this long-time timer delay circuit 32 times out a command, it is sent to the coulomb counters to “load” the digital signal into the counters. After a sufficiently long delay when the battery is idle, this signal is representative of the open circuit voltage, and is also representative of the remaining battery capacity. Loading the signal into the coulomb counters initializes or resets the count to the actual remaining capacity in the battery.

In operation, when a charge or discharge current flows through the current sensing circuit 10, for example, a shunt resistor as illustrated, the coulomb counters respond as it does in existing technology. The polarity and amplitude of the current is detected and the coulomb counters 18, 20 and 22 count energy flowing into or out of the battery.

If so desired, the state of charge indicator 10 is easily adapted to count and display battery charge/discharge cycles as well the state of charge of the battery. The count registered by coulomb counters for either charge or discharge cycles is accumulated in a non-resetable register or other memory device indicated generally by the dashed lines at 40, which could be a separate component as illustrated and integral with other illustrated components. The total accumulated coulomb count (in amperes) divided by the battery capacity rating (in amperes) is typically equal to the equivalent number of full charge/discharge cycles that the battery has been subjected.

This accumulated coulomb count may be read out externally via a communications bus in one non-limiting example. Alternatively, the battery cycle count could be displayed on a device, such as the five-segment display 28, e.g., a bar graph commonly used to display a battery state of charge. The cycle count might be displayed as 50 cycles per segment, for example. This count could even be displayed using the same display that is used for the state of charge indicator by pressing a switch to display a battery cycle count. When the switch is released, the battery state of charge is again displayed.

The circuit as described is operative with battery cell chemistries such as Lithium-Ion whose open circuit voltage is an accurate indication of battery capacity regardless of the battery temperature. However, the open circuit voltage of other capacities can vary greatly with temperature and by itself, may not be a good indication of remaining battery capacity.

The above-described circuit could be adapted in several ways to overcome the temperature issue. A temperature sensor 42 may be placed in the battery that detects the battery temperature and enables the resetting of a coulomb counter only when the temperature is in a range where the open circuit voltage is an accurate indication of the remaining battery capacity, or a temperature sensor and electronic circuitry may be placed in the battery that detects the battery temperature and corrects the resetting of the coulomb counter based on the measured open circuit voltage and the temperature of the battery.

This circuit as described could have another application where the battery may be removable from the radio or other equipment that it is powering. In this case, using a battery, either primary or secondary, the coulomb counter should be initialized as it has no way to detect the state of charge of the battery. In this application the coulomb counter may be initialized in the manner described above.

In yet another application a variation of this circuit may be used as a separate tool that can be plugged into a battery, primary or secondary, to indicate the remaining state of charge. Many batteries are provided with caps or dust covers that plug into the battery connector to protect the battery from being inadvertently shorted. The circuit as described may be built into the protective cp or dust cover so as to provide an instant, real time indication of the state of charge of the battery without the need for any external meters or other test equipment.

An example of the number of segments that could be displayed, such as a bar or stars in a five-segment display is shown below, as a non-limiting example.

| % of Capacity Remaining | Display |
|---|---|
| 100 to 90 | ***** |
| 90 to 70 | **** |
| 70 to 50 | *** |
| 50 to 30 | ** |
| 30 to 10 | * |
| 10 to 5 | * FLASHING |
| 5 TO 0 | |

| Number of Cycles | | |
|---|---|---|
| Remaining | % of Life Remaining | Display |
| 300 to 270 | 100% to 90% | ***** |
| 270 to 210 | 90% to 70% | **** |
| 210 to 150 | 70% to 50% | *** |
| 150 to 90 | 50% to 30% | ** |
| 90 to 30 | 30% to 10% | * |
| 30 to 0 | 10% to 0% | |

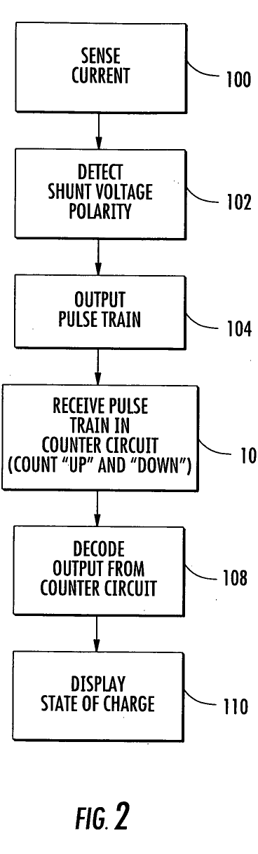

A high-level flowchart in FIG. 2 illustrates basic functions of the representative circuit shown in FIG. 1. Current is sensed (Block 100) and a charge/discharge comparator detects shunt voltage polarity (Block 102). A voltage-controlled oscillator outputs a pulse train having a frequency directly proportional to the sensed battery current (Block 104).

A counter circuit receives the pulse train and counts the pulses as “up” for charge and “down” for discharge as determined by the charge/discharge comparator (Block 106). Output from the counters is decoded (Block 108) and displayed (Block 110).

An optically activated switch could also be used where the user could put a finger over the optically activated switch blocking the light to the switch to display the battery cycle count. Removal of the finger causes the display to revert back to displaying the battery state of charge.

An example of an optically activated switch is disclosed in commonly assigned U.S. Pat. No. 6,900,615, the disclosure which is hereby incorporated by reference in its entirety. The circuit as described could be modified for use with the circuit shown in FIG. 1. A battery casing could include an opening that forms a “window” for exposing a light sensing circuit to light. This opening could include a lens, such as a transparent or substantially translucent lens, which can be formed from glass, plastic or other material known to those skilled in the art. The lens can be positioned within the opening and sealed to form a watertight barrier to moisture and water. A removable and opaque cover can be positioned over the opening and lens to block light from passing onto the light sensing circuit until the cover is removed. This opaque cover could be a label or opaque, pull tab that is adhesively secured to the battery casing and over the lens. Once the cover or tab is pulled from the casing, ambient light passes through the lens through the opening, and onto the light sensing circuit to actuate a circuit.

As noted before, the lens is preferably mounted in the opening in a watertight seal to prevent water from seeping into the battery casing and creating a fire hazard or explosion by contacting any lithium or other hazardous cells that have not been completely discharged. This watertight seal is provided by the lens with the battery casing and not by any pull-tab, label or other cover that is positioned over the opening.

A latch circuit could latch the circuit into an ON condition even when the light sensing circuit is no longer exposed to light. A non-latching circuit could also be used.

An arming circuit can be provided that arms the light sensing circuit for operation after battery assembly. Thus, during the initial manufacturing process, the light sensing circuit and other battery circuits are disarmed and not operable. Any exposure of the light sensing circuit to light will not activate any circuits. At final assembly, however, the light sensing circuit, such as a light sensor, for example, a photocell, can be installed in the battery casing through a battery casing opening and the opaque label placed over the lens positioned in the opening or “window.” When the circuit is armed, a casing cover or lid can be attached and sealed to the battery casing. This arming circuit could be formed as a simple switch, a removable jumper connection, or printed circuit card, a break-off tab, which once broken off, would allow the casing cover to be placed thereon.

An arming circuit could use an operational amplifier as a differentiator with a potential difference in its terminals. Any operational amplifier could include an inverting input terminal and a non-inverting input terminal, appropriate voltage supply terminals, and an output terminal. An operational amplifier could have a positive feedback loop circuit and loop back resistor that increases output and allows the operational amplifier to drive harder to saturation. Any operational amplifier could switch state to turn on a transistor acting as a switch, such as an NPN transistor, which connects to a light emitting diode and resistor circuit having a resistor network. The light emitting diode also emits light and acts as a visual indication of circuit activation.

The light sensing circuit could include a light dependent resistor (as a non-limiting example), which can be formed such as by cadmium sulfide or other resistor material. The light dependent resistor has a resistance value that decreases when exposed to light. The light dependent resistor could be operatively connected in series to a capacitor, and both could be parallel with a voltage divider circuit having two resistors to provide a voltage divided input to the inverting input terminal. The capacitor could be designed with circuit components to provide some low pass or other filtering function. It could also provide momentary disarm (when initially connecting to the battery). When transistor is switched ON, in conjunction with the switched state of the operational amplifier, circuit activation occurs even though the resistor is no longer exposed to light. The light dependent resistor and capacitor could also form a divider circuit that provides the input to a non-inverting input terminal that receives the positive feedback from the output terminal.

This arming circuit could also be formed as a jumper line and provide a current flow direct to an inverting input terminal. If the light dependent resistor is exposed to light, and the resistance of the light dependent resistor drops, the jumper line as illustrated provides a “short” to the inverting input terminal such that an operational amplifier would not saturate and switch operating states. Thus, the operational amplifier would not bias a transistor ON to actuate a circuit and operate the light emitting diode. This jumper line could be formed as part of the circuit card on a tab, such that before the battery casing cover is placed on the battery casing, the breakable tab formed on the circuit card is broken to break the circuit line connection, as illustrated, and arm the circuit.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed:

1. A state of charge indicator system for a battery, which comprises:
a current sensing circuit for sensing and converting charge or discharge current of the battery into a bipolar voltage with one polarity representative of charge current and an opposite polarity representative of discharge current;
a counter circuit for that counts battery charge;
a charge/discharge circuit operatively connected to said current sensing circuit and said counter circuit that detects the voltage polarity from the current sensing circuit and sets the counter circuit to a count mode with an up or down count for a respective charge or discharge; and
a reset circuit operative with the current sensing circuit, counter circuit and charge/discharge circuit for resetting the counter circuit to an actual sate of charge at the battery after a delay when said battery is idle representative of a battery open circuit voltage.

2. A state of charge indicator system according to claim 1, and further comprising a voltage measuring circuit operatively connected to said counter circuit for measuring battery terminal voltage and transmitting a digital signal representative of said battery terminal voltage to said counter circuit.

3. A state of charge indicator system according to claim 2, wherein said reset circuit comprises a timer circuit operative with said counter circuit for loading a digital signal from the voltage measuring circuit into said counter circuit after a delay when said battery is idle as representative of a battery open circuit voltage and representative of remaining capacity for resetting the count within the counter circuit to the remaining battery capacity.

4. A state of charge indicator system according to claim 3, and further comprising a voltage-controlled oscillator operatively connected to said current sensing circuit and said counter circuit and outputting a pulse signal to said counter circuit having a frequency proportional to the battery current through said current sensing circuit.

5. A state of charge indicator system according to claim 4, wherein said reset circuit further comprises a comparator circuit operative with said voltage-controlled oscillator and said timer circuit for activating the timer circuit when said battery is idle.

6. A state of charge indicator system according to claim 1, wherein said current sensing current comprises a shunt device for producing a shunt bipolar voltage.

7. A state of charge indicator system according to claim 1, wherein said charge/discharge circuit comprises a comparator that receives the bipolar voltage and detects voltage polarity and differentiates between battery charge and discharge.

8. A state of charge indicator system according to claim 1, wherein said charge/discharge circuit is operative for setting the counter circuit to have an up count for charge and down count for discharge.

9. A state of charge indicator system according to claim 1, wherein said counter circuit comprises a coulomb counter.

10. A state of charge indicator system according to claim 9, and further comprising a plurality of serially connected coulomb counters.

11. A state of charge indicator system according to claim 1, and further comprising a logic circuit operatively connected to said counter circuit for receiving any output from said counter circuit and outputting a display drive signal, and a display operatively connected to said logic circuit for receiving the display drive signal and displaying the state of charge of the battery.

12. A state of charge indicator system for a battery, which comprises:
a counter circuit that counts battery charge;
a voltage measuring circuit operatively connected to said counter circuit for measuring battery terminal voltage and transmitting a digital signal representative of said battery terminal voltage to said counter circuit; and
a circuit operative with said counter circuit and voltage measuring circuit for monitoring current and detecting when the battery has been idle, indicative that the battery has neither been charged nor discharged for a period of time sufficient for allowing the battery to settle into an open circuit voltage state and resetting the counter circuit to an actual state of charge of the battery.

13. A state of charge indicator for a battery according to claim 12, and further comprising a shunt device for producing a shunt bipolar circuit with one polarity representative of charge current and an opposite polarity representative of discharge current.

14. A state of charge indicator for a battery according to claim 12, which further comprises a timer circuit operative with said counter circuit for loading the digital signal from the voltage measuring circuit into said counter circuit after a delay when said battery is idle representative of the battery open circuit voltage and representative of remaining capacity for resetting the count within the counter circuit to the remaining battery capacity

15. A state of charge indicator for a battery according to claim 12, which further comprises a voltage-controlled oscillator operatively connected to said counter circuit and outputting a pulse signal to said counter circuit having a frequency proportional to the battery current through said current sensing circuit.

16. A state of charge indicator for a battery according to claim 15, which further comprises a comparator circuit operative with said voltage-controlled oscillator and said timer circuit for activating the timer circuit when said battery is idle.

17. A state of charge indicator for a battery according to claim 12, which further comprises a charge/discharge circuit that receives the bipolar voltage and detects voltage polarity and differentiates between battery charge and discharge.

18. A method of indicating a state of charge for a battery, which comprises:
converting the charge or discharge current of the battery into a bipolar voltage with one polarity representative of charge current and an opposite polarity representative of discharge current;
counting battery charge within a counter circuit;
detecting voltage polarity of the battery and setting the counter circuit to a count mode with an up or down count for respective charge or discharge; and
resetting the counter circuit to an actual state of charge of the battery after a delay when said battery is idle representative of the battery open circuit voltage

19. A method according to claim 18, which further comprises measuring battery terminal voltage and transmitting a digital signal representative of said battery terminal voltage to said counter circuit.

20. A method according to claim 18 which further comprises outputting a pulse signal from a voltage-controlled oscillator to said counter circuit having a frequency proportional to the battery current and inhibiting the voltage-controlled oscillator when battery charge or discharge current is below a predetermined minimum value.
